(19) United States
(12) Patent Application Publication
(10) Pub. No.: US 2009/0004625 A1
(43) Pub. Date: Jan. 1, 2009

(54) Dental Drilling Assembly

(76) Inventors: Alessio Esposti, Woluwe St. Lambert (BE); Carl Van Lierde, Meerbeke (BE)

Correspondence Address: BACON & THOMAS, PLLC, 625 SLATERS LANE, FOURTH FLOOR, ALEXANDRIA, VA, 22314-1176, US

(21) Appl. No.: 12/087,671

(22) PCT Filed: Jan. 12, 2006
(86) PCT No.: PCT/EP2006/000220

§ 371 Date: Jul. 11, 2008

(51) Int. Cl. A61C 3/02

(52) U.S. Cl. 433/165

(57) ABSTRACT

A dental drilling assembly comprises a drill (30) and a bushing (40) which is mounted, or mountable, coaxially with the drill (30). The bushing (40) can be inserted with the drill (30) into a bore hole of a surgical template and can similarly be removed from the bore hole when a hole has been drilled. The bushing has a serrated leading edge (51) for cutting soft gingival tissue. A pathway (54, 55) is defined between the drill (30) and the bushing (40). The pathway (54, 55) cooperates with a fluted channel on the drill and serves, in use, to evacuate soft tissue from the cutting surface (51). A surgical template has at least one bore hole representing a position where the drill is required to be used. The bore hole, or a bore tube lining the bore hole, has a diameter which is only slightly larger than the bushing.

### FIELD OF THE INVENTION

This invention relates to a dental drilling assembly which can be used to drill holes in the bone of a patient for the fitting of dental implants as well as a method of manufacture of and using the assembly.

### BACKGROUND TO THE INVENTION

In dental treatment methods and devices are known for determining the ideal placement of an implant. Such treatment methods typically consist of a number of steps. Firstly a diagnostic wax-up is created to represent the desired prosthetic end result. The wax-up is optimized to achieve proper occlusion, morphology, aesthetics and phonetics. Next, a scanning template or scan prosthesis is manufactured. This is a replica of the wax-up made in a radio-opaque material to ensure that it is clearly visible in the medical images when the patient is scanned.

Following production of the scan template, the patient is sent to a radiologist for scanning (CT, MRI or the like). The output of the scan is a stack of 2D slices forming a three-dimensional data set. From this data set virtual 3D models can be constructed and a planning project is established. The surgeon uses this project to plan the implant positions and inclinations using a computer program such as SimPlant™. The computer program allows the individual patient's CT images to be assessed in a three-dimensional way and to determine where dental implants can be placed ideally. Implants can be chosen from a digital implant library (different implant brands, lengths, diameters, etc.) Several cross sections can be selected perpendicular to both the arch of the jaw curve and the axial slices. Typically, implant receptor sites are chosen in these cross-sections. The practitioner can modify the positions and inclinations of each implant as needed in any of the available views. Fine-tuning is achieved by shifting or tilting of the implant representations or by changing their dimensions. Each individual implant position can be evaluated in terms of the volume of available bone. The quality of the bone is visualized in the computer program using Hounsfield units as a measure for bone density.

Once the implant plan has been fixed, it must be transferred to the patient as accurately as possible. US patent US2005/0170301A1 describes a method and device for placing dental implants. A custom-made surgical template that has an exact mating region in the mouth of the patient (either on the jawbone, the gums or the teeth) has bore tubes with predetermined positions and inclinations. Drill bushings are inserted into the bore tubes in the template and these serve to guide step drills and calibrating drills to create implant cavities in the jaw of the patient. After drilling, the aforementioned drill bushings are removed from the template and the implants are placed through the bore tubes in a guided manner. Fixture mounts are then attached on top of the implants. The fixture mounts glide into the bore tubes fixed in the surgical template.

One of the disadvantages of the described method relates to the removal of the drill bushings. Due to limited space in the mouth of the patient, manipulating the drill bushings is difficult. Typically, once holes have been drilled in the jaw, the surgical template must be removed from its position in the patient's mouth to take out the drill bushings. The template is then repositioned.

An additional problem occurs when the surgical template is fitted directly on the soft tissue or the teeth of the patient. Indeed when no surgical flap is made the presence of soft tissue overlying the respective implantation sites in the jaw is troublesome. If the implant cavities are drilled without firstly removing the soft tissue locally, gingival matter can be dragged into the bone cavity and can contaminate the implantation site, eventually leading to implant failure. Alternative solutions include marking the position where the implant is required through the template using a tissue marker. The template is then removed, the tissue is removed from the marked area, and the template is replaced. This adds further steps to the overall implant process and presents a risk that the template is replaced in a different position in the mouth.

### SUMMARY OF THE INVENTION

An object of the present invention is to provide an improved dental drilling assembly which can be used to drill holes in the bone of a patient for the fitting of dental implants as well as a method of manufacture of and using the assembly.

An advantage of the present invention is that it can overcome at least one of the problems of the prior art devices mentioned above.

A first aspect of the present invention provides a dental drilling assembly comprising a drill and a bushing which is mounted, or mountable, coaxially with the drill. By having the bushing mounted, or mountable, to the drill, the bushing can be inserted with the drill into a bore hole of a surgical template and can similarly be removed from the bore hole when a hole has been drilled. This avoids the need to remove the surgical template from the mouth of the patient after drilling operations to remove a bushing from the template. The bushing can be permanently mounted to the drill, or the bushing can be removably mountable to the drill such as by a bayonet or corkscrew type of fixing.

Preferably, the bushing has at least one cutting surface for cutting soft tissue. The cutting surface can comprise a serrated leading edge of the bushing, a knife-edge or any other suitable form. This has the advantage of avoiding the need to use a separate tissue cutting tool. Such tools may normally require the removal of the surgical template from the patient's mouth.

Preferably, a pathway is defined between the drill and the bushing which serves, in use, to evacuate soft tissue from the cutting surface. This ensures soft tissue is removed from the cutting site and helps to prevent contamination of the implant site.

The dental drilling assembly is used in connection with a surgical template having at least one bore hole representing a position where the drill is required to be used, the bore hole having a diameter which accommodates the drill and bushing. Where the bore hole is lined with a bore tube, the bore tube has a diameter which accommodates the drill and bushing. Preferably the bore hole, or bore tube, has a diameter which is only slightly larger than the bushing so that the bushing is accommodated with a sliding fit. This helps to ensure an accurate positioning of the drill at the required drilling site.

### BRIEF DESCRIPTION OF THE DRAWINGS

Embodiments of the invention will be described, by way of example only, with reference to the accompanying drawings in which:

FIG. 1 shows a cross-section of a scan prosthesis used during a preparatory stage of the implant operation;

FIG. 2 shows a drilling jig (surgical template) used when drilling holes in the jaw bone of a patient;

FIG. 3 provides a schematic representation of a drilling assembly according to an embodiment of the present invention engaged in the bore tube of a surgical template;

FIG. 4 shows a connection between a drill and bushing which ensures that the torque applied to the drill is also transmitted to the bushing;

FIGS. 5 and 6 depict a bushing with a flange for providing control over the depth of the protrusion of the drill assembly in the surgical template in accordance with an embodiment of the present invention;

FIG. 7 shows another embodiment of the drilling assembly, in which the bushing has a serrated cutting edge;

FIG. 8 shows another view of the drilling assembly of FIG. 7;

FIG. 9 shows the bushing that is part of the drilling assembly of FIGS. 7 and 8.

FIG. 10 shows further embodiments of the present invention including arrangements of bushing and drill.

### DESCRIPTION OF PREFERRED EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

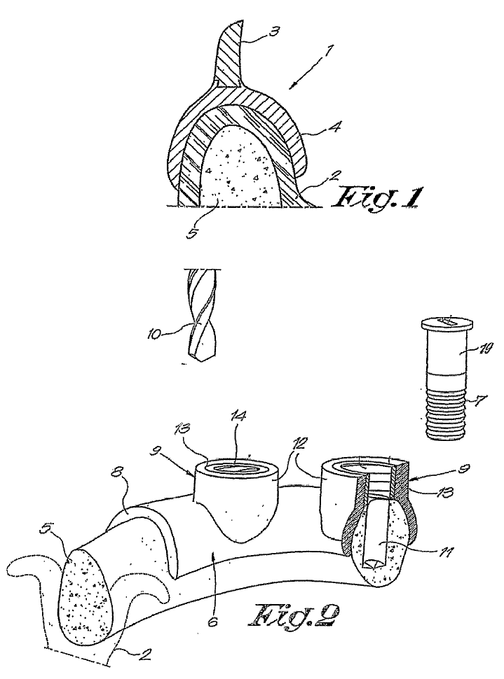

Before describing the drilling assembly in detail, the initial steps of an implant process and the apparatus used in the process will be described. The aim of the process is to create a dental superstructure which will fit on implants which have been fixed in the jaw bone of a patient. The superstructure supports artificial teeth. With the intention of creating a superstructure, a diagnostic setup of the future teeth will first be made. This is normally achieved using an articulator, i.e. an appliance in which two teeth molds or plaster models/casts can be positioned in correct relation to one another enabling the simulation of realistic jaw movement. The diagnostic setup is made on plaster models of the remaining teeth or gums that indicates the future positions of the teeth. The same test arrangement is also copied in a radio-opaque material in order to make a scan prosthesis 1, as represented in FIG. 1, the purpose of which will become clear from the further description. According to a variant of the method, instead of realizing this diagnostic setup in a mechanical articulator, the test arrangement can also be made virtually, with a computer, by means of what is called a virtual articulator which can simulate the movements of the upper jaw in relation to the lower jaw. In this case, the jaws of the patient or a cast thereof will be scanned, for example with a laser scanner. The two scanned jaws are positioned in relation to one another by registering the respective teeth surfaces on each other, or by scanning one of the jaws with an mouldable paste on top of it, such that the surface of one jaw corresponds exactly to the other jaw.

Next, teeth can be chosen from a digital library and positioned in those places where teeth are missing. After this preliminary stage, preferably as a first step of the actual method, a computer planning is made in view of the placement of the implants. This can be done, for example, by first scanning the patient with a computed tomography scanner (CT-scanner) and by simulating the implants on the CT-scans, as described in the Belgian patent No. 1.011. 205. It is useful that the patient is scanned with what is called a scan prosthesis 1 as represented in FIG. 1. This is a copy of the loose prosthesis of the patient or of the diagnostic setup made by means of an articulator. This scan prosthesis 1, which is placed on the gums or mucosa 2 during the scanning, is made of a radio-opaque material which is thus visible in the CT-images, whereby the teeth 3 of this scan prosthesis 1 have another degree of opacity than the base part 4 supported on the gums or the mucosa 2, which covers the bone of the patient.

The teeth 3 can be made of any suitable material such as an acrylic resin mixed with 30% of barium sulfate, while the rest of the prosthesis 1 is made of a less radio opaque materials such as a mixture of acrylic resin and 10% of barium sulfate. This offers the advantage that the teeth 3 are nicely visible in the CT scan images and can thus be segmented separately in a simple manner. In addition, the shape of the gums 2 will also be visible, as the base part 4 of the scan prosthesis 1 can be identified and delineates the gums and its lower side represents the shape of the gums. Furthermore, the shape of the surface of the bone 5 is perfectly visible by means of the CT-scan. Next, a drill jig or surgical template 6 is created. This drill jig can possibly also serve as a fitting jig, since the implants 7 can be placed by means of it. Implant placement can possibly also be achieved with a separate fitting jig. The template 6, and possibly the fitting jig, can for example be made by means of Rapid Prototyping techniques, as described in the Belgian patent No. 1.011. 205.

According to FIG. 2, the template 6 fits on part 8 of the bone 5 of the patient (after the gums 2 have been opened) and enables pre-operative transferal of the drill directions in conformity with the planning of the surgeon. To this end, the template 6 has ducts 9 for one or several drills 10. It should be noted that the bone 5 may have a very irregular surface. As the template 6 is designed based on data coming from the CT-scan, the part of the jig in contact with the bone will have an inner surface 8 which always follows the shape of the irregular surface very precisely. The result is that there will always be an accurate positioning. It should also be noted that, according to a variant, said template, fitting jig and possibly even said positioning jig, can be provided with a contact part which is not or not solely designed to be supported on the bone 5, but (also) cooperates with parts of the gums 2 and/or remaining teeth of the patient The template 6 is used when drilling holes 11 for implants 7. The template 6 has been designed such that it can be used for all implants 7. This template 6 is put only once on the patient and is possibly screwed down temporarily. The ducts 9 are, as shown, preferably composed of several parts. First, there are a number of guiding tubes 12, preferably in the form of collars, which make up one piece together with the contact part of the template 8. The ducts 9 are lined with bore tubes 14 which is made of, for example, metal.

According to an aspect of the present invention metal bore tubes may or may not be present in the template. The bushing that is mounted over the drills is preferably made from metal but this is not mandatory. Alternative materials are included within the scope of the present invention such as some structural plastics and types of hard plastics.

If the template 6 is to be used as a fitting jig, implants are fitted through the bore tubes 14. Implants 7 and individually mounted to holders 19.

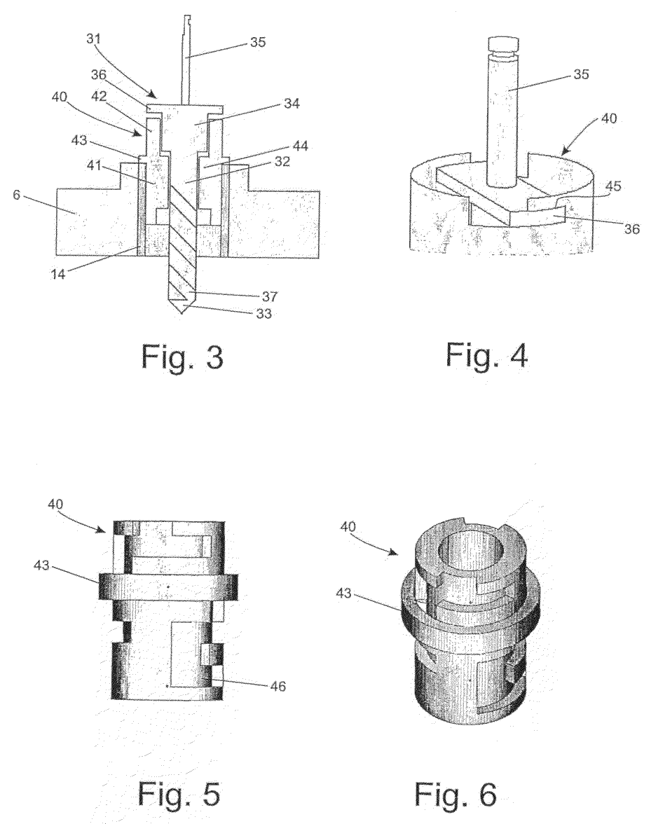

FIG. 3 shows a drill assembly according to an embodiment of the invention which can be used in connection with the surgical template 6. Drills are typically cooled with water during an intervention there will always a certain degree of hydraulic lubrication. FIG. 3 shows a cross section of the template with a guiding cylinder lined by a bore tube into which the drill with bushing has been inserted. Drill 30 has a body 32 which extends between a drilling tip (apical end of the drill) 33 and a margin 34 (coronal end of the drill). A shank 35 extends longitudinally from the margin 34. The shank 35 locates in a handpiece (not shown) which drives the drill. The handpiece can use any suitable drive to drive the drill, e.g. an electrical motor or pneumatic turbine in a known manner. In this embodiment the drill has a single drilling tip. In alternative embodiments the drill 30 can be a staged drill, where the body 32 comprises a plurality of drill sections of progressively increasing diameter in the direction from the drill tip 33 towards the margin 34. This serves to create a hole of progressively increasing width as the drill is driven into the bone 5. The size of the head of the drill (i.e. the margin 34) in FIG. 3 has been exaggerated. In fact this is the cylindrical portion of land which is not cut away to provide clearance.

The drill 30 is provided with a bushing 40 which is mounted coaxially about the longitudinal axis of the drill 30. The bushing 40 is a tubular structure having a generally cylindrical shape. The bushing has a flange 43 radially extending from the outer surface of the bushing 40. In use, flange 43 rests on a bore tube 14 of the template 6. A first portion 41 of the bushing 41, positioned below the flange 43, locates inside a bore tube 14 and a second portion of the bushing 41 sits above the bore tube 14. Bushing 40 has a radially inwardly-extending collar 44.

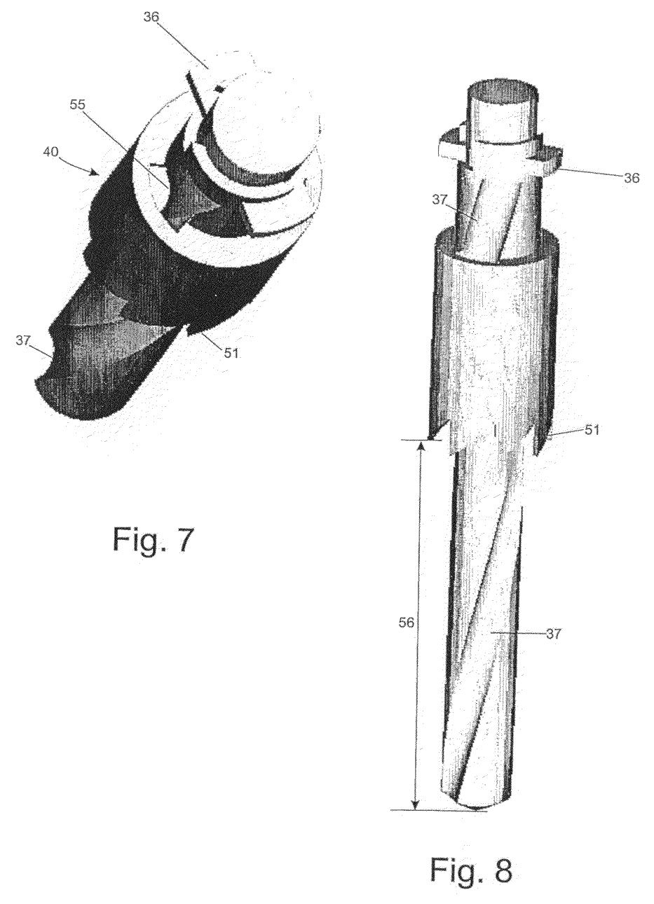

In use, a bushing 40 is used which has an outer diameter slightly less than the inner diameter of the bore tube 14. This allows the bushing and drill to slide within the bore tube 14 of the surgical template 6. This sliding fit has a centering effect on the drill 30 and serves to ensure an accurate alignment of the drill with the required drill position and direction/inclination dictated by the bore tube 14. Although bore tubes 14 are shown here, it is alternatively possible to use the template without any bore tubes 14 and the bushing 40 fits directly within a hole in the surgical template 6. The bushing 40 can be permanently mounted to the drill 30 or, more preferably, is removably mounted to the drill 30. This allows a set of differently-sized bushings 40 to be used. In this embodiment, the bushing 40 is mountable to the drill so that torque is transmitted between the drill and the bushing, i.e. the bushing 40 rotates with the drill 30. As best shown in FIG. 4, a connection between the drill 30 and bushing 40 can take the form of a bayonet 36 which locates in slots 45 in the bushing 40. The connection is arranged such that the bayonet is driven into the slots 45 as the drill 30 is rotated in it's normal working direction. A particular feature of the connection is a stabilizing zone of at least 1 mm. Such a stabilizing zone can be created as a close fit (i.e. tolerances of for example 0.02 mm) between the bushing 40 and the drill 30 over a suitable length such as at least 1 mm. The stabilizing zone can be identified in FIGS. 7 and 8. It is the short tubular region of the bushing 40 in between the bayonet connection, e.g. 36 and the bone chip evacuation holes, e.g. 55 provide in the bushing 40.

Referring to FIG. 5, the flange 43 can be positioned at different positions in the longitudinal direction along bushing 40. The flange 43 comprises a collar having two or more radially inwardly-protruding teeth. These teeth engage in circumferential grooves 46 on the bushing. The grooves are positioned at intervals along the longitudinal axis of the bushing 40. The grooves 46 can be designed slightly tapered or conical so the teeth firmly grab into them, thus clicking into position.

The pattern of grooves comprises a number of discrete positions. To go to from one position to a consecutive position, the tooth engaging in the groove must follow the pattern. Each position is located at an angle relative to the previous one. Though this is not required it offers the advantage that the wall thickness of the bushing will not be diminished over it's entire length but only over short distances which differ radially. This contributes to the strength of the component.

Each lateral groove has a starting point (where the tooth first engages) and an end point (where the tooth is eventually blocked). The grooves can be conical or tapered in the sense that the width of the groove at the starting point can be larger than at the end point. Thus, as the tooth engages lower down in the groove, the tolerances between tooth and groove become smaller and smaller increasing friction between the components so they are fixed or jammed into position.

A drilling operation using the drill and bushing will now be described. In use, and as best shown in FIG. 3, flange 43 serves as a depth control during a drilling operation. Bushing 40 is secured to drill 30 and thus both move together as the drill 30 is inserted into a bore tube 14 of template 6. Initially, the lower shoulder of bushing 40 slides into a bore tube 14. This centres the drill 30 and guides the drill. Eventually, when the drill 30 has reached a particular drilling depth into bone 5, flange 43 on the outside of bushing 40 rests on the upper shoulder of the bore tube 14 and the drill 30 is prevented from drilling any deeper.

Although a bayonet type of fitting is shown in FIG. 4 other types of fixing are possible, such as a corkscrew fitting where complementary screw threads are provided on the outer surface of drill 30 and on the inner surface of bushing 40. These can be provided, for example, in the region of the stabilizing zone. The threads on the respective pieces engage with one another to create a secure, but reversible, connection. The fixing can include any suitable fixing means, such as a screw thread, a button-operated quick-release mechanism, bayonet connection, magnet, etc.

A removable bushing provides at least one of the following advantages:
Ease of cleaning, e.g. of the bushing and/or drill
Different lengths/diameters of bushings are possible. This is important because of differences in implant brands. While the drill can be the same, only a relatively cheap component such as the bushing needs to be manufactured.
Life span of the components. Removing soft tissue is less demanding than drilling in the bone. The bushing may be used multiple times whereas the drill may be for single or limited use.
Freedom to select different materials, e.g. bushing in plastic; drill in metal.

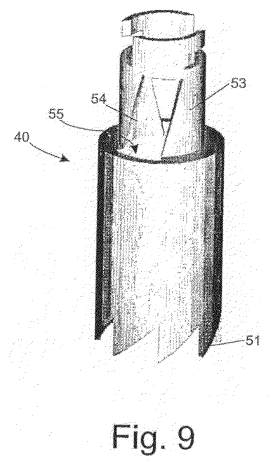

FIGS. 7 to 9 show another embodiment of the invention in which the leading edge of the bushing 40 (the lower edge as shown in FIG. 8) is provided with a cutting surface. In one form this cutting surface is a serrated edge 51 comprising a set of teeth 52 or a knife-edge. Typically, the size of the teeth 52 will vary between 0 and 0.6 mm. The size of the teeth measured in a direction parallel to the axis of the bushing. Typically, smaller teeth will allow more teeth to be placed along the circumference.

Alternative cutting surfaces are included within the scope of the invention. In case of a knife edge the rim of the bushing will be processed such that the wall thickness is reduced to a sharp edge. This creates a very sharp circular “blade”. The blade coincides with the rim of the bushing.

Such a sharp edge may be used to perform a local circular cut in the soft tissue without removing bone. It is preferred that the cutting edge of the bushing should be adapted in material and form so that it can only cut through the soft tissue but cannot continue to cut through the bone.

The (wall) thickness of the teeth typically lies in a range between 0.2 and 0.5 mm. This cutting function helps to cleanly cut soft tissue material from the site where the implant will be fitted. Cutting the soft tissue as part of the drilling operation improves accuracy of the position of the cut, and avoids the need to use other tools, which may require the removal of the template from the patient's mouth.

FIGS. 7-9 do not show a flange 43 as in FIG. 3, however, the figures are only illustrative. A flange may or may not be present also in the embodiment shown in FIGS. 7-9.

It is desirable that soft gingival tissue is removed from the site of the cutting operation. A tissue evacuation pathway is provided between the drill 30 and bushing 40. The flute 37 of the drill serves to remove material from the drill tip 33 towards the coronal end of the drill. This flute 37 can also help to carry soft tissue material from the region adjacent the cutting surface 51 to the coronal end of the drill. A channel 55 is provided through the bushing 40, which is aligned with the flute 37. This allows the flute to perform a material moving function in an unrestricted manner. The pathway is continued at the upper portion of the bushing. Spiral slots 54 align with the flute 37 on the drill 30. The upper section of the bushing has spiral slots aligned with the flute. The spiral slots in the bushing extend from the pathway upwards. They need not (but can) run all the way through to the top of the bushing provided that this does not compromise the strength of the components.

It is preferred that the distance 56 between the lower edge of the cutting surface 51 of the bushing 40 and the drill tip 33 lies in a range, e.g. between 3 to 4 mm. This corresponds to the average soft tissue thickness of a patient. The limitation assures that the bushing always centres the drill when it engages in the bone of the patient. The 3-4 mm distance controls the distance by which the drill extends beyond the bushing—in other words, the drill will always drill 3-4 mm deeper than the bushing.

If the drill extends only 3-4 mm relative to the bushing and the depth of the soft tissue equals this size, it is physically impossible to drill inside bone without the bushing engaging in a guiding cylinder. If the drill would extend further, for instance 8 mm, the minimum height of the guiding cylinder would need to be 5 mm to make sure that the drill is centred in the template.

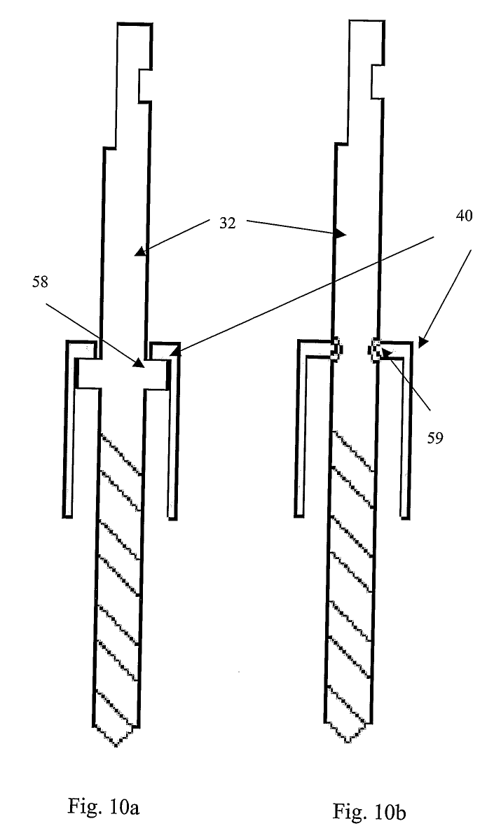

In the embodiments described above torque applied to the drill is transmitted to the bushing. According to another embodiment of the invention the drill 30 can rotate freely with respect to the bushing 40 and there is no such transmission of torque between the parts. In this alternative embodiment the bushing does not perform a cutting operation and only performs a stabilising and guiding function for the drill. Different arrangements are included within the scope of the present invention:
The drill 32 could be provided with a flange 58 on which the bushing rests without limiting the rotation of the drill itself but limiting off-axis movement. (see FIG. 10a)
Fixed connection via some type of bearing, e.g. a ball bearing
Tooth-groove type connection, i.e. the top surface of the bushing 40 locates into a recess in the drill 32 as shown at position 59 of FIG. 10b while still allowing rotation.

The invention is not limited to the embodiments described herein, which may be modified or varied without departing from the scope of the invention.

1-16. (canceled)

17. A dental drilling assembly comprising a drill and a bushing which is mounted, or mountable, coaxially with the drill, the bushing having at least one cutting surface for cutting soft tissue, the dental drilling assembly further comprising a surgical template having at least one bore hole representing a position where the drill is required to be used, the bore hole having a diameter which accommodates the drill and bushing.

18. The dental drilling assembly according to claim 17, wherein the bushing is mounted, or mountable, coaxially with the drill for rotating with the drill.

19. The dental drilling assembly according to claim 17, wherein the at least one cutting surface comprises a serrated leading edge of the bushing.

20. The dental drilling assembly according to claim 19, wherein a drilling tip of a drill extends a distance of 3 to 4 mm from a leading edge of the bushing.

21. The dental drilling assembly according to claim 18, wherein a pathway is defined between the drill and the bushing which serves, in use, to evacuate soft tissue from a cutting surface.

22. The dental drilling assembly according to claim 21, wherein the drill comprises a fluted channel on the outer surface of the drill and the pathway comprises at least one channel in a support between the bushing and the drill which is aligned with the fluted channel.

23. The dental drilling assembly according to claim 17, wherein the bushing further comprises a flange which extends radially outwardly from the bushing.

24. The dental drilling assembly according to claim 23, wherein the flange is positionable at a plurality of positions along the longitudinal axis of the drill.

25. The dental drilling assembly according to claim 17, wherein the drill and the bushing are mounted, or mountable, such that in use torque is transmitted between the drill and the bushing.

26. The dental drilling assembly according to claim 17, wherein the drill and the bushing are mounted, or mountable, such that in use the drill is rotatable with respect to the bushing.

27. The dental drilling assembly according to claim 17, wherein the drill and the bushing are removably connectable to one another.

28. The dental drilling assembly according to claim 27, wherein the connection between the drill and bushing comprises a bayonet or corkscrew fixing.

29. The dental drilling assembly according to claim 17, wherein a stabilising interface between the bushing and a shank of the drill extends along the longitudinal axis of the bushing.

30. The dental drilling assembly according to claim 17, wherein the bore hole is lined with a bore tube and the bore tube has a diameter which accommodates the drill and bushing.

31. The dental drilling assembly according to claim 30, wherein the bore hole or bore tube has a diameter which accommodates the drill and bushing in a sliding fit.
